(19) United States
(12) Patent Application Publication
(10) Pub. No.: US 2014/0172411 A1
(43) Pub. Date: Jun. 19, 2014

(54) APPARATUS AND METHOD FOR VERIFYING CONTEXT

(71) Applicant: Electronics and Telecommunications Research Institute, Daejeon (KR)

(72) Inventors: Chang Hyun KIM, Daejeon (KR); Oh Woog Kwon, Daejeon (KR); Seung Hoon Na, Daejeon (KR); Yoon Hyung Roh, Daejeon (KR); Young Ae Seo, Daejeon (KR); Seong Il Yang, Daejeon (KR); Ki Young Lee, Daejeon (KR); Sang Keun Jung, Daejon (KR); Sung Kwon Choi, Daejeon (KR); Yun Jin, Daejeon (KR); Eun Jin Park, Daejeon (KR); Jong Hun Shin, Daejeon (KR); Jinxia Huang, Daejeon (KR); Sang Kyu Park, Daejeon (KR)

(73) Assignee: Electronics and Telecommunications Research Institute, Daejeon (KR)

(21) Appl. No.: 14/040,036

(22) Filed: Sep. 27, 2013

(30) Foreign Application Priority Data
Dec. 17, 2012 (KR) 10-2012-0147536

(51) Int. Cl. G06F 17/28

(52) U.S. Cl. CPC G06F 17/2854
USPC 704/2

(57) ABSTRACT

Provided are an apparatus and a method for verifying a context that verify an ambiguous expression of an input text through a user's intention and utilize the verified expression as a context in interpretation and translation. The apparatus includes: an ambiguous expression verifying unit verifying an ambiguous expression in a first input text or a back translation text for the first input text in accordance with user's input; a context generating unit generating the verified ambiguous expression as a context; and a context controlling unit controlling the generated context to be applied to translate or interpret the first input text or second input texts input after the first input text.

### CROSS-REFERENCE TO RELATED APPLICATIONS

This application claims priority to and the benefit of Korean Patent Application No. 10-2012-0147536 filed in the Korean Intellectual Property Office on Dec. 17, 2012, the entire contents of which are incorporated herein by reference.

### TECHNICAL FIELD

The present invention relates to an apparatus and a method for verifying a context for interpretation and translation. More particularly, the present invention relates to an apparatus and a method for verifying a context for interactive automatic interpretation and translation.

### BACKGROUND

In automatic interpretation and translation apparatuses which have been released, an apparatus that translates a native language into a foreign language and an apparatus that translates the foreign language into the native language operate independently from each other. Therefore, when the automatic interpretation and translation apparatuses interpret and translate dialogue of foreigners into the native language or interpret and translate dialog of a user into the foreign language, the automatic interpretation and translation apparatuses independently interpret and translate the dialogue regardless of dialogue contents with the other party. Due to this reason, the automatic interpretation and translation apparatuses cannot utilize a context which conforms with an overall flow of the dialogue and an error occurs in interpretation and translation as inappropriate contexts are applied to interpretation and translation.

In recent years, as a scheme for solving the problem, an automatic interpretation and translation apparatus that utilizes all interactive dialogue contexts has been discussed. However, the automatic interpretation and translation apparatus has a problem that an error occurs in interpretation and translation by using an ambiguous word to which user's intention is incorrectly reflected as the context, and as a result, a problem that communication is cut off, and the like may also occur.

### SUMMARY

The present invention has been made in an effort to provide an apparatus and a method for verifying a context that verify an ambiguous expression of an input text through user's intention and utilize the verified expression as the context in interpretation and translation.

An exemplary embodiment of the present invention provides an apparatus including: an ambiguous expression verifying unit verifying an ambiguous expression in a first input text or a back translation text for the first input text in accordance with user's input; a context generating unit generating the verified ambiguous expression as a context; and a context controlling unit controlling the generated context to be applied to translate or interpret the first input text or second input texts input after the first input text.

The ambiguous expression verifying unit may include a meaning dividing output unit dividing the ambiguous text into single-meaning texts containing respective meanings and outputting the corresponding texts in the case where an ambiguous text is provided as the ambiguous expression; and a first selective input unit selectively receiving any one single-meaning text or single-meaning word among the single-meaning texts or the single-meaning words from the user.

The meaning dividing output unit may divide and output the respective single-meaning texts according to paraphrasing or divide and output the respective single-meaning words into characters or images.

The meaning dividing output unit may sequentially arrange the single-meaning texts in any one part of an upper part and a lower part of the ambiguous text on one window in one direction and output the arranged single-meaning texts, sequentially arrange and output only single-meaning texts on an additional window in one direction, sequentially arrange and output the single-meaning words in any one part of upper, lower, left, and right parts of the ambiguous word in one direction on one window, or sequentially arrange and output only the single-meaning words on an additional window in one direction.

The first selective input unit may output at least one button between a corresponding text selection button and a corresponding text non-selection button at one side of each single-meaning text or output at least one button between a corresponding word selection button and a corresponding word non-selection button at one side of each single-meaning word.

The ambiguous expression verifying unit may include a first back translation text output unit outputting a back translation text together with the first input text before delivering the translation text for the first input text to a user's counterpart; an identity input unit inputting whether the back translation text and the first input text have a meaning identity; an other meaning phrase output unit outputting a single-meaning word or a single-meaning phrase containing a meaning other than an output meaning of an ambiguous word or an ambiguous phrase of the first input text which has a different meaning from the back translation text in the case where the input indicates that the back translation text and the first input text do not have the meaning identity; and a second selective input unit receiving whether the output single-meaning word or single-meaning phrase is selected from the user in the case where the number of the output single-meaning words or single-meaning phrase is one and selectively receiving from the user any one single-meaning word or single-meaning phrase among the output single-meaning words or single-meaning phrases in the case where the number of the output single-meaning words or single-meaning phrase is at least two.

The second selective input unit may include a word/phrase output unit outputting the single-meaning word or the single-meaning phrase when the number of the single-meaning words or the single-meaning phrases is one; and a selection input unit receiving from the user whether the output single-meaning word or single-meaning phrase is to be selected, and the ambiguous expression verifying unit may further include an other phrase input unit receiving other single-meaning words or single-meaning phrases from the user when the user does not select the output single-meaning or single-meaning phrase.

The second selective input unit may include a word/phrase arranging unit sequentially arranging and outputting the single-meaning words or the single-meaning phrases in one direction in any one part of upper, lower, left, and right parts of the ambiguous word or the ambiguous phrase or sequentially arranging and outputting only the single-meaning words or the single-meaning phrases on an additional window when the number of the single-meaning words or the single-meaning phrases is at least two; and a word/phrase choosing unit selectively receiving from the user any one single-meaning word or single-meaning phrase among the single-meaning words or the single-meaning phrases.

The word/phrase choosing unit may output at least one button between a corresponding word selection button and a corresponding word non-selection button at one side of each single-meaning word or output at least one button between a corresponding phrase selection button and a corresponding phrase non-selection button at one side of each single-meaning phrase.

The ambiguous expression verifying unit may include a retranslation input unit transferring the translation text for the first input text to the user's counterpart and thereafter, receiving whether the translation text is to be retranslated from the user according to a counterpart's reaction for the translation text; a second back translation text output unit outputting the back translation text together with the first input text when the input is the retranslation request of the translation text; an identity input unit inputting whether the back translation text and the first input text have a meaning identity; an other meaning phrase output unit outputting a single-meaning word or a single-meaning phrase containing a meaning other than an output meaning of an ambiguous word or an ambiguous phrase of the first input text which has a different meaning from the back translation text in the case where the input indicates that the back translation text and the first input text do not have the meaning identity; and a second selective input unit receiving whether the output single-meaning word or single-meaning phrase is selected from the user in the case where the number of the output single-meaning words or single-meaning phrase is one and selectively receiving from the user any one single-meaning word or single-meaning phrase among the output single-meaning words or single-meaning phrases in the case where the number of the output single-meaning words or single-meaning phrase is at least two.

The retranslation input unit may include a message output unit outputting a message to request retranslation of the translation text when the counterpart who receives the translation text has no response for a predetermined time or a word or a phrase that means that the translation text is unable to be understood is included in the counterpart's response; and a message response unit receiving whether the translation text is to be retranslated from the user who verifies the message.

The retranslation input unit may include a response output unit outputting a response of the counterpart who receives the translation text; and a message response unit receiving whether the translation text is to be retranslated from the user who verifies the response.

The response output unit may output the response as a character input by the counterpart or an image acquired by photographing a counterpart's gesture.

The ambiguous expression verifying unit may use a text input through the voice or a text input through an input device such as a key pad or a touch pad as the first input text.

The apparatus for verifying a context may be mounted on a server that provides at least one function of a messenger function, an interactive translation function, and an interactive interpretation function between the first user terminal that outputs the input text through the first language and the second user terminal that outputs the input text through the second language or mounted on a terminal with at least one program of an interactive translation program and an interactive interpretation program and an input device.

Another exemplary embodiment of the present invention provides a method for verifying a context: verifying an ambiguous expression in a first input text or a back translation text for the first input text in accordance with user's input; generating the verified ambiguous expression as a context; and controlling the generated context to be applied to translate or interpret the first input text or second input texts input after the first input text.

The verifying of the ambiguous expression may include dividing the ambiguous text into single-meaning texts containing respective meanings and outputting the corresponding texts in the case where an ambiguous text is provided as the ambiguous expression and dividing the ambiguous word into single-meaning words containing respective meanings and outputting the corresponding words in the case where an ambiguous word is provided as the ambiguous expression; and selectively receiving any one single-meaning text or single-meaning word among the single-meaning texts or the single-meaning words from the user.

In the meaning dividing outputting, the respective single-meaning texts may be divided and output according to paraphrasing or the respective single-meaning words are divided and output into characters or images.

In the meaning dividing output unit, the single-meaning texts are sequentially arranged in any one part of an upper part and a lower part of the ambiguous text on one window in one direction and output the arranged single-meaning texts, only single-meaning texts are sequentially arranged on an additional window in one direction, the single-meaning words are sequentially arranged in any one part of upper, lower, left, and right parts of the ambiguous word in one direction on one window, or only the single-meaning words are sequentially arranged on an additional window in one direction.

In the first selective inputting, at least one button between a corresponding text selection button and a corresponding text non-selection button is output at one side of each single-meaning text or at least one button between a corresponding word selection button and a corresponding word non-selection button is output at one side of each single-meaning word.

The ambiguous expression verifying may include outputting a first back translation text together with the first input text before delivering the translation text for the first input text to a user's counterpart; inputting whether the back translation text and the first input text have a meaning identity; outputting a single-meaning word or a single-meaning phrase containing a meaning other than an output meaning of an ambiguous word or an ambiguous phrase of the first input text which has a different meaning from the back translation text in the case where the input indicates that the back translation text and the first input text do not have the meaning identity; and receiving whether the output single-meaning word or single-meaning phrase is selected from the user in the case where the number of the output single-meaning words or single-meaning phrase is one and selectively receiving from the user any one single-meaning word or single-meaning phrase among the output single-meaning words or single-meaning phrases in the case where the number of the output single-meaning words or single-meaning phrase is at least two.

The second selective inputting may include outputting the single-meaning word or the single-meaning phrase when the number of the single-meaning words or the single-meaning phrases is one; and receiving from the user whether the output single-meaning word or single-meaning phrase is to be selected, and the ambiguous expression verifying may further include receiving other single-meaning words or single-meaning phrases from the user when the user does not select the output single-meaning or single-meaning phrase.

The second selective inputting may include sequentially arranging and outputting the single-meaning words or the single-meaning phrases in one direction in any one part of upper, lower, left, and right parts of the ambiguous word or the ambiguous phrase or sequentially arranging and outputting only the single-meaning words or the single-meaning phrases on an additional window when the number of the single-meaning words or the single-meaning phrases is at least two; and selectively receiving from the user any one single-meaning word or single-meaning phrase among the single-meaning words or the single-meaning phrases.

In the word/phrase choosing, at least one button between a corresponding word selection button and a corresponding word non-selection button may be output at one side of each single-meaning word or at least one button between a corresponding phrase selection button and a corresponding phrase non-selection button may be output at one side of each single-meaning phrase.

The ambiguous expression verifying may include transferring the translation text for the first input text to the user's counterpart and thereafter, receiving whether the translation text is to be retranslated from the user according to a counterpart's reaction for the translation text; outputting the back translation text together with the first input text when the input is the retranslation request of the translation text; inputting whether the back translation text and the first input text have a meaning identity; outputting a single-meaning word or a single-meaning phrase containing a meaning other than an output meaning of an ambiguous word or an ambiguous phrase of the first input text which has a different meaning from the back translation text in the case where the input indicates that the back translation text and the first input text do not have the meaning identity; and receiving whether the output single-meaning word or single-meaning phrase is selected from the user in the case where the number of the output single-meaning words or single-meaning phrase is one and selectively receiving from the user any one single-meaning word or single-meaning phrase among the output single-meaning words or single-meaning phrases in the case where the number of the output single-meaning words or single-meaning phrase is at least two.

The retranslation inputting may include outputting a message to request retranslation of the translation text when the counterpart who receives the translation text has no response for a predetermined time or a word or a phrase that means that the translation text is unable to be understood is included in the counterpart's response; and receiving whether the translation text is to be retranslated from the user who verifies the message.

The retranslation inputting may include outputting a response of the counterpart who receives the translation text; and receiving whether the translation text is to be retranslated from the user who verifies the response.

In the response outputting, the response may be output as a character input by the counterpart or an image acquired by photographing a counterpart's gesture.

In the ambiguous expression verifying, a text input through the voice or a text input through an input device such as a key pad or a touch pad may be used as the first input text.

The method for verifying a context may be performed on a server that provides at least one function of a messenger function, an interactive translation function, and an interactive interpretation function between the first user terminal that outputs the input text through the first language and the second user terminal that outputs the input text through the second language or performed on a terminal with at least one program of an interactive translation program and an interactive interpretation program and an input device.

The present invention can achieve the following effects by the object and the configuration.

First, a context error is verified and only an accurate context is used as a context under a context based interactive dialogue automatic interpretation and translation environment in which context information about a dialogue history of both parties that make a dialogue and translation process information is secured and shared to improve interpretation and translation qualities of an interactive automatic interpretation and translation apparatus and smoothly communicate with a dialogue counterpart.

Second, active reactions and solutions for errors of an original text and a translation can be presented by adopting a multi-verification structure while verifying the context, and as a result, qualitative/temporal enhancement of communication using automatic interpretation and translation can be achieved.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a schematic configuration diagram of a first interactive interpretation and translation system including an apparatus for verifying a context according to the present invention.

FIG. 2 is a block diagram schematically illustrating an internal configuration of an interactive interpretation and translation server illustrated in FIG. 1.

FIG. 3 is a block diagram illustrating an internal configuration of a context based interpretation and translation unit illustrated in FIG. 2.

FIG. 4 is a schematic configuration diagram of a second interactive interpretation and translation system including an apparatus for verifying a context according to the present invention.

FIG. 5 is a schematic block diagram of an interactive interpretation and translation terminal illustrated in FIG. 4.

FIG. 6 is a block diagram schematically illustrating an internal configuration of a context verifying unit according to an exemplary embodiment of the present invention.

FIG. 7 is a block diagram illustrating an internal configuration of an ambiguous expression verifying unit illustrated in FIG. 6.

FIGS. 8 and 9 are exemplary diagrams for describing analysis and verification of an original text.

FIG. 10 is a block diagram illustrating an internal configuration of a second selective input unit illustrated in FIG. 7 and a configuration added to the ambiguous expression verifying unit.

FIG. 11 is a block diagram illustrating an internal configuration of a retranslation input unit illustrated in FIG. 7.

FIG. 12 is a flowchart schematically illustrating a method for verifying a context according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings.

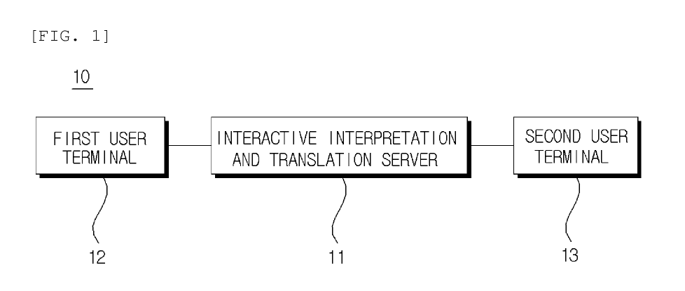

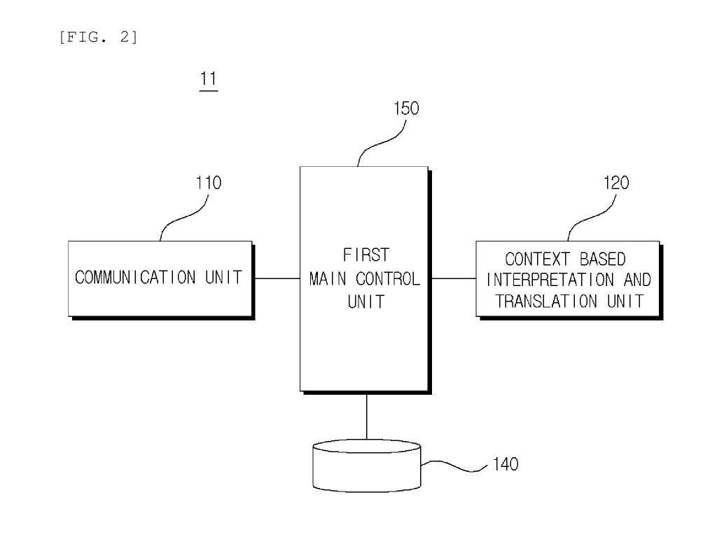

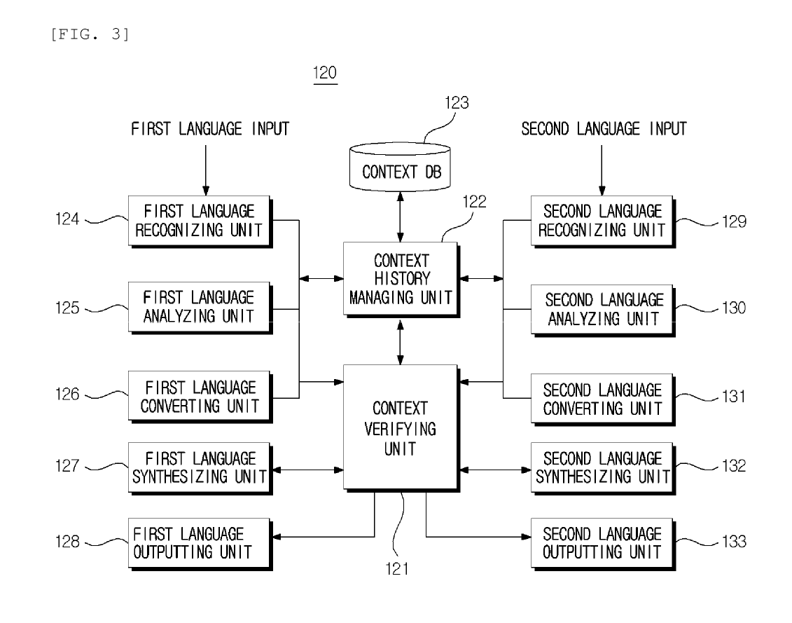

FIG. 1 is a schematic configuration diagram of a first interactive interpretation and translation system including an apparatus for verifying a context according to the present invention. FIG. 2 is a block diagram schematically illustrating an internal configuration of an interactive interpretation and translation server illustrated in FIG. 1. FIG. 3 is a block diagram illustrating an internal configuration of a context based interpretation and translation unit illustrated in FIG. 2.

A first interactive interpretation and translation system 100 is a system in which interpretation and translation are performed under an interactive environment such as a messenger. The first interactive interpretation and translation system 10 verifies texts which are prevented from being used as a context between an original text and a translated text which appear during interpretation and translation at the time of removing ambiguity of a text to be translated at present by using the original text and a translated text result under an interactive interpretation and translation environment in which a first language is interpreted and translated into a second language and the second language is interpreted and translated into the first language and utilizes only information which is verified to be appropriate as the context as the context and applies the information to provide more accurate and faster automatic interpretation and translation results.

In FIG. 1, the first interactive interpretation and translation system 10 includes an interactive interpretation and translation server 11, a first user terminal 12, and a second user terminal 13.

The first user terminal 12 as a terminal, which a user making use of the first language accesses, may be implemented as a mobile apparatus or a computer.

The second user terminal 13 as a terminal which a user making use of the second language accesses may be implemented as the mobile apparatus or the computer, similarly as the first user terminal 12. In the exemplary embodiment, the first language and the second language are different from each other and for example, in the case where the first language is Korean, the second language corresponds to languages other than the Korean, that is, English, and the like.

The interactive interpretation and translation server 11 as a general server performs an interactive automatic interpretation and translation function based on a context in the exemplary embodiment. The interactive interpretation and translation server 11 may be implemented by a translation server, an interpretation server, a messenger server, and the like. The interactive interpretation and translation server 11 may be implemented by a terminal type such as the mobile apparatus or the computer in the exemplary embodiment even though the interactive interpretation and translation server 11 is expressed as a server.

In FIG. 2, the interactive interpretation and translation server 11 includes a communication unit 110, a context based interpretation and translation unit 120, a database 140, and a first main control unit 150.

The communication unit 110 receives an interpretation and translation target input text from the first user terminal 12 and transmits an interpretation and translation result for the input text to the second user terminal 13. The communication unit 110 receives the interpretation and translation target input text even from the second user terminal 13 and transmits the interpretation and translation result to the first user terminal 12.

The context based interpretation and translation unit 120 generates the interpretation and translation result for the input text by using the context. In particular, the context based interpretation and translation unit 120 first verifies the context and thereafter, generates the interpretation and translation result by using the verified context.

In FIG. 3, the context based interpretation and translation unit 120 includes a context verifying unit 121, a context history managing unit 122, a context DB 123, a first language recognizing unit 124, a first language analyzing unit 125, a first language converting unit 126, a first language synthesizing unit 127, a first language outputting unit 128, a second language recognizing unit 129, a second language analyzing unit 130, a second language converting unit 131, a second language synthesizing unit 132, and a second language outputting unit 133.

The context verifying unit 121 verifies an ambiguous expression through a user's intention and utilizes the verified expression as the context in interpretation and translation. The context verifying unit 121 may be implemented in an interface type in the exemplary embodiment. The context verifying unit 121 will be described below in more detail.

The context history managing unit 122 serves to control the context verified by the context verifying unit 121 to be stored in the context DB 123 or provide the context stored in the context DB 123 to be utilized at the time of interpreting and translating the input text.

The first language recognizing unit 124 receives the first language (ex., English) as voice or a text through the first user terminal 12 to perform a function to recognize the voice or text.

The first language analyzing unit 125 serves to analyze a morpheme and a structure of the recognized first language.

The first language converting unit 126 serves to convert the analyzed first language into the second language (ex., Korean).

The first language synthesizing unit 127 serves to process the second language generated through the conversion in an outputtable type. The first language synthesizing unit 127 may generate the second language in the voice or text type.

The first language outputting unit 128 serves to output the second language to the first user terminal 12.

The second language recognizing unit 129 receives the second language (ex., Korean) as the voice or text through the second user terminal 13 to perform the function to recognize the voice or text.

The second language analyzing unit 130 serves to analyze the morpheme and the structure of the recognized second language.

The second language converting unit 131 serves to convert the analyzed second language into the first language (ex., English).

The second language synthesizing unit 132 serves to process the first language generated through the conversion in the outputtable type. The second language synthesizing unit 132 may generate the first language in the voice or text type.

The second language outputting unit 133 serves to output the first language to the second user terminal 13.

The database 140 stores various information for performing the interpretation and translation function, the interpretation and translation result, and the like. When the context DB 123 is not provided in the context based interpretation and translation unit 120, the database 140 stores even the context.

The first main control unit 150 controls all operations of the respective components constituting the interactive interpretation and translation server 110.

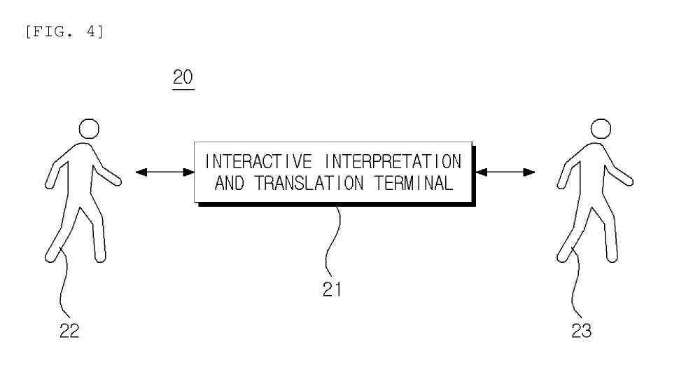

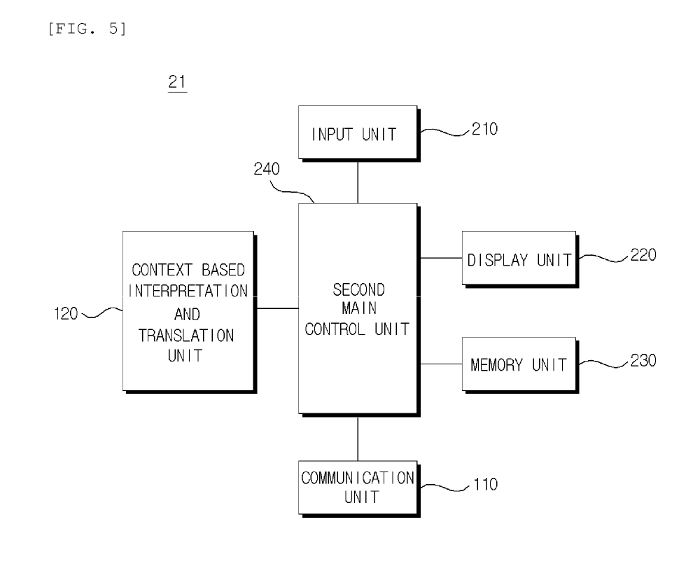

FIG. 4 is a schematic configuration diagram of a second interactive interpretation and translation system including an apparatus for verifying a context according to the present invention. FIG. 5 is a schematic block diagram of an interpretation and translation terminal illustrated in FIG. 4.

In FIG. 4, a second interactive interpretation and translation system 20 includes an interactive interpretation and translation terminal 21, a first user 22, and a second user 23.

The first user 22 represents a user making use of the first language and the second user 23 is a user making use of the second language.

The interactive interpretation and translation terminal 21 performs the same function as the interactive interpretation and translation server 11 of FIG. 1 such as the interactive automatic interpretation and translation function based on the context. However, the interactive interpretation and translation terminal 21 is implemented as the terminal type such as the mobile apparatus or the computer unlike the interactive interpretation and translation server 110.

The interactive interpretation and translation terminal 21 includes an input unit 210, a context based interpretation and translation unit 120, a display unit 220, a memory unit 230, a communication unit 110, and a second main control unit 240 as illustrated in FIG. 5.

The input unit 210 receives the interpretation and translation target input text from the first user 22. The input unit 210 receives the input text even from the second user 23 at the time of considering interactivity.

The input unit 210 may receive user's voice as the input text. In this case, the input unit 210 may be implemented as a microphone (MIC). Meanwhile, the input unit 210 may receive the input text through user's touch. In this case, the input unit 210 may be implemented as a key pad or a touch pad.

The display unit 220 displays the input text or the interpretation and translation result of the input text.

The memory unit 230 stores a program for performing the interpretation and translation function, the input text received from the first user 22 or the second user 23, the interpretation and translation result of the input text, and the like.

The second main control unit 240 controls all operations of the respective components constituting the interactive interpretation and translation terminal 21.

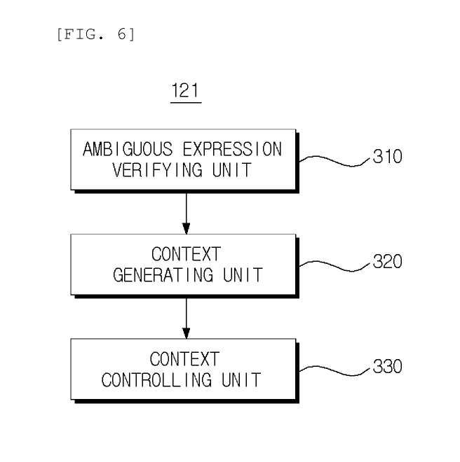

Next, the context verifying unit 121 of FIG. 3 will be described. FIG. 6 is a block diagram schematically illustrating an internal configuration of a context verifying unit according to an exemplary embodiment of the present invention.

When the context verifying unit 121 constructs an interactive dialogue context at the time of performing the interactive automatic interpretation and translation, only an accurate context is constructed by verifying whether the context is erroneous to remove a waste of a dialogue which may occur due to a wrong context and provide a correct translation result.

All information associated with an analysis result and an interpretation and translation result generated while interpreting and translating the text has a value as the context and the context information provides information which is useful to appropriately correctly translate a current translation target text. A case in which the useful information is provided will be described as an example.

Previous text: I'm look forward to coming spring.

Current text: When did you order spring?

In the above dialogue situation, when a previous text is correctly translated, the following type of context may be constructed.

Context:

I, am, look forward to, coming, spring

I/noun, come/verb, spring/noun . . .

. . .

The context may be variously used while translating the text. Some of various ambiguity which occurs while translating a text.

spring/season, spring/twisted wire, . . .

During the conversion, as “spring” may be converted into both “a season” and “twisted wire”. Even in this case, “spring/season” may be selected as correct conversion through the context.

However, when the context is incorrectly constructed due to translation errors of previous texts, a function of the context does not help solving ambiguity during the translation process and rather exerts a bad influence on the translation process. Examples in which a result of the bad influence is caused through the aforementioned examples are described below.

Dialogue 1—English dialogist: “I'm look forward to coming spring.”
→“Na-Neun Bom-I O-Gi-Reul Gi-Da-Rin-Da.”

Dialogue 2—Korean dialogist: “I like spring too.”
→“Na-Do Bom-Eul Joh-A-Hae.”

. . .

Dialogue 3—English dialogist: “I bought spring in the toy store yesterday.”
→“Na-Neun Eo-Je Jang-Nan-Gam-Ga-Ge-E-Seo Yong-Su-Cheol-Eul Gu-Ip-Haet-Da.”

Dialogue 4—Korean dialogist: “What?”
→“Mwo-Ra-Go?”

Dialogue 5—English dialogist: “Why?”
→“Wae?”

. . .

Dialogues 1 and 2 are already configured as the contexts to exert an influence on translation of Dialogue 3. “spring/season” is constructed in the context information through Dialogues 1 and 2 and the information is continuously used during the translation process from now on. As a result, “spring” of the current text is translated into “season” and the translation error serves as a core element which impedes the dialogue from being normally made from now on.

Therefore, a incorrectly constructed contest causes a lot of problems in translation from now on, and only when the problems are reduced as hurriedly as possible, a correct translation is enabled and a smooth dialogue is enabled.

In order to construct the correct context, it is verified whether the corresponding context is the correct context in several steps as early as possible and whether the corresponding context is the correct context is notified to the user to determine whether the corresponding context is the correct context and information verified as the correct context needs to be constructed as the context which is correct as possible.

The context verifying unit 121 includes an ambiguous expression verifying unit 310, a context generating unit 320, and a context controlling unit 330.

The ambiguous expression verifying unit 310 serves to verify an ambiguous expression in a first input text or a back translation text for the first input text according to user's input. The ambiguous expression verifying unit 310 may use a text input through the voice or a text input through an input device such as a key pad or a touch pad as the first input text.

The context generating unit 320 serves to generate the verified ambiguous expression as the context.

The context controlling unit 330 serves to control the generated context to be applied to translate or interpret the first input text or second input texts input after the first input text.

In the exemplary embodiment, the context verification may be performed as any one of original text analysis verification, translation result verification, and response based verification. In FIG. 6, the ambiguous expression verifying unit 310 performs the context verification. Hereinafter, each verification will be described in detail.

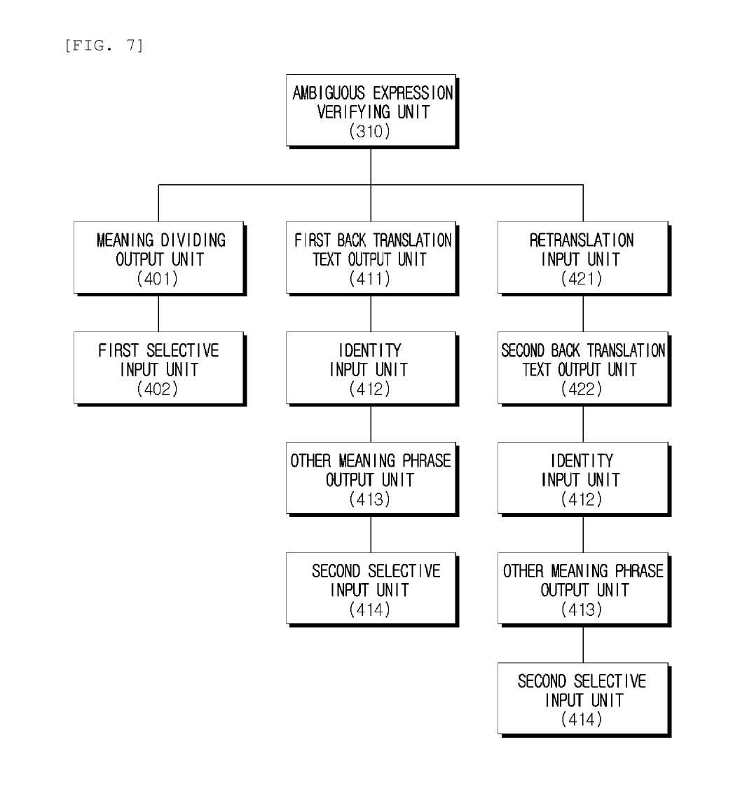

FIG. 7 is a block diagram illustrating an internal configuration of an ambiguous expression verifying unit illustrated in FIG. 6. In FIG. 7, a meaning division output unit 401 and a first selective input unit 402 are components for the original text analysis verification, and a first back translation text output unit 411, an identity input unit 412, an other meaning phrase output unit 413, and a second selective input unit 414 are components for the translation result verification. A retranslation input unit 421, a second retranslation text output unit 4222, and the identity input unit 412, the other meaning phrase output unit 413, and the second selective input unit 414 are components for the response based verification.

\textcircled{1} Original Text Analysis Verification

In the case where an ambiguous text is provided as the ambiguous expression, the meaning division output unit 401 divides the ambiguous text into single-meaning texts containing respective meanings and outputs the corresponding texts. In the case where an ambiguous word is provided as the ambiguous expression, the meaning division output unit 401 divides the ambiguous word into single-meaning words containing respective meanings and outputs the corresponding words.

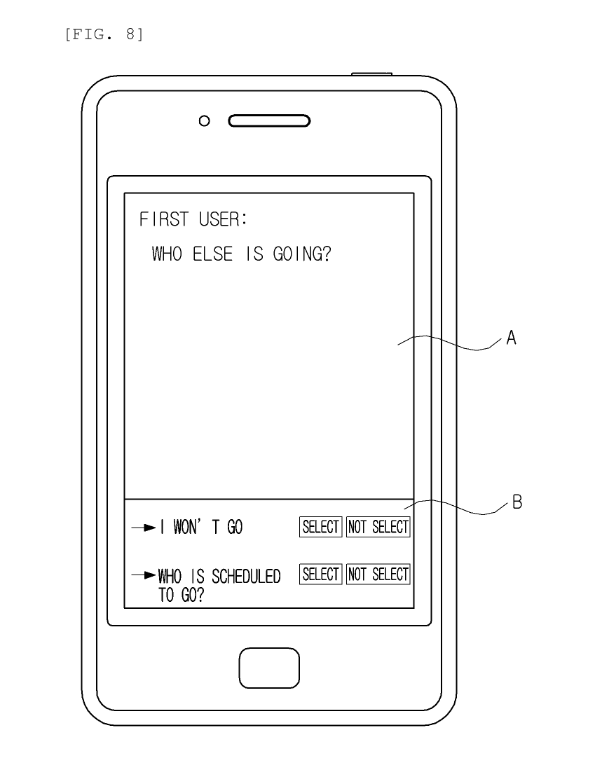

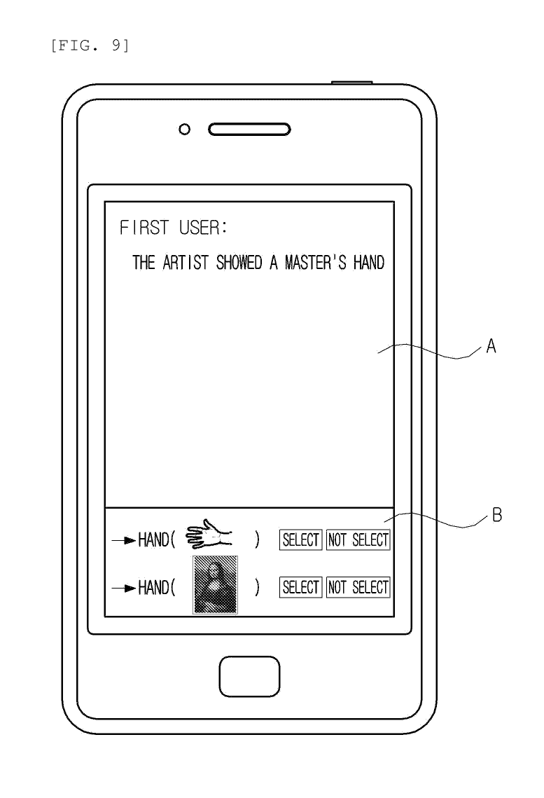

The meaning dividing output unit 401 divides and outputs the respective single-meaning texts according to paraphrasing or divides and outputs the respective single-meaning words into characters or images. An example of the former is illustrated in FIG. 8 and an example of the latter is illustrated in FIG. 9. In FIGS. 8 and 9, A means an information display window that displays a dialogue content and B means a message window that displays an analysis result for the ambiguous expression included in the dialogue content.

The meaning dividing output unit 401 sequentially sorts single-meaning texts in any one part of upper and lower parts of the ambiguous text in one direction on one window and outputs the corresponding single-meaning texts or sequentially sorts only the single-meaning texts on an additional window in one direction and outputs the sorted single-meaning texts, at the time of outputting the single-meaning texts. The meaning dividing output unit 401 sequentially sorts single-meaning words in any one part of upper, lower, left, and right parts of the ambiguous word in one direction on one window and outputs the corresponding single-meaning words or sequentially sorts only the single-meaning words on an additional window in one direction and outputs the sorted single-meaning words, at the time of outputting the single-meaning words. An example of the case where only the single-meaning texts are output on the additional window is illustrated in FIG. 8 and an example of the case where only the single-meaning texts are output on the additional window is illustrated in FIG. 9.

The first selective input unit 402 selectively receives any one single-meaning text or single-meaning word among the single-meaning texts or the single-meaning words from the user. Herein, the user represents a narrator between the first user and the second user.

The first selective input unit 402 outputs at least one button between a corresponding text selection button and a corresponding text non-selection button at one side of each single-meaning text or outputs at least one button between a corresponding word selection button and a corresponding word non-selection button at one side of each single-meaning word. An example of a case where both the selection button and the non-selection button are output is illustrated in FIGS. 8 and 9.

The original analysis verification has an intention of allowing the user to evaluate an analysis result of an ambiguous expression which is present in an original text to first correctly interpret and translate the ambiguous expression and thus, finally acquire a correct context. The original text analysis verification may be performed largely in two types as illustrated in FIGS. 8 and 9.

The example of FIG. 8 discloses a method of removing ambiguity by changing an original text with ambiguity into an original text without ambiguity by paraphrasing. “Who else is going?” has two ambiguity of a meaning that “I won't go” and a meaning that “Who is scheduled to go?” and verifies the meaning of the corresponding text to the user to enable accurate translation. If a translation engine analyzes the corresponding text as the meaning that “Who is scheduled to go?” while the user's intention is that “I won't go”, the user modifies the wrong analysis to enable the accurate translation.

The example of FIG. 9 discloses a method of allowing the user to evaluate the meaning of the ambiguous expression in a translation target text. In the case of “The artist showed a master's hand.”, various meanings (part of body, help, Role in situation, needle of clock/watch, worker, sailor, writing, skill, and the like) “hand” are presented and verified to the user to enable the accurate translation. In the case where an actual user's intended meaning is “The artist showed a master's hand (@ part of body)” while a text meaning presented to the user is “The artist showed a master's hand (@ skill)”, the user correctly select the corresponding meaning to enable the accurate translation.

\textcircled{2} Translation Result Verification

The first back translation text output unit 411 serves to output a back translation text together with the first input text before delivering the translation text for the first input text to a user's counterpart. The first back translation text output unit 411 may output both the back translation text and the original text.

The identity input unit 412 serves to input whether the back translation text and the first input text have a meaning identity.

In the case where the input indicates that the back translation text and the first input text do not have the meaning identity, the other meaning phrase output unit 413 serves to output a single-meaning word or a single-meaning phrase containing a meaning other than an output meaning of an ambiguous word or an ambiguous phrase of the first input text which has a different meaning from the back translation text.

The second selective input unit 414 serves to receive whether the output single-meaning word or single-meaning phrase is selected from the user in the case where the number of the output single-meaning words or single-meaning phrase is one and selectively receive from the user any one single-meaning word or single-meaning phrase among the output single-meaning words or single-meaning phrases in the case where the number of the output single-meaning words or single-meaning phrase is at least two. An original text and a translation text in which ambiguity is removed according to the input of the second selective input unit 414.

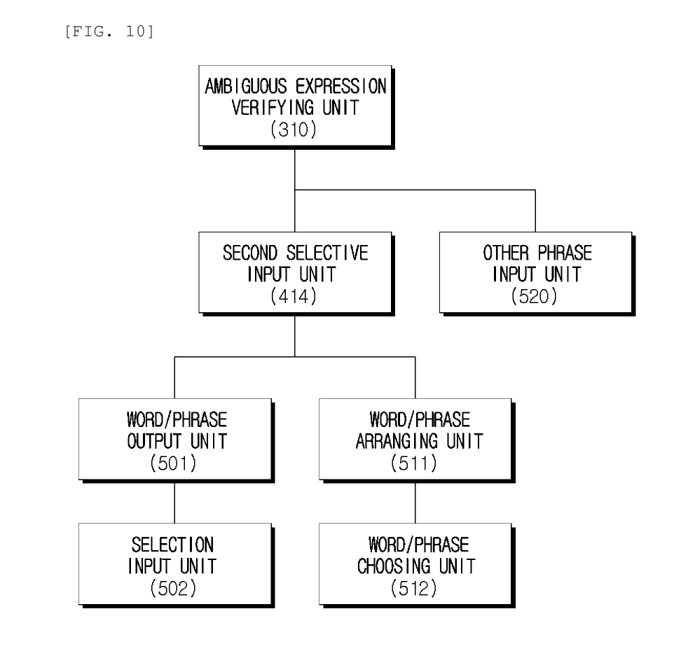

FIG. 10 is a block diagram illustrating an internal configuration of a second selective input unit illustrated in FIG. 7. FIG. 10 illustrates even components which may be added to the ambiguous expression verifying unit.

In FIG. 10, when the number of the single-meaning words or the single-meaning phrases is one, the second selective input unit 414 may include a word/phrase output unit 501 and a selection input unit 502.

The word/phrase output unit 501 outputs the single-meaning word or the single-meaning phrase. In this case, the single-meaning word is outputtable in an image type in addition to a character similarly as the case of the original text analysis verification.

The selection input unit 502 receives from the user whether the output single-meaning word or single-meaning phrase is to be selected.

Meanwhile, the ambiguous expression verifying unit 310 may further include an other phrase input unit 520.

The other phrase input unit 520 is configured to receive other single-meaning words or single-meaning phrases from the user when the user does not select the output single-meaning word or single-meaning phrase.

When the number of the single-meaning words or the single-meaning phrases is at least two, the second selective input unit 414 may include a word/phrase arranging unit 511 and a word/phrase choosing unit 512.

The word/phrase arranging unit 511 sequentially arranges and outputs the single-meaning words or the single-meaning phrases in one direction in any one part of upper, lower, left, and right parts of the ambiguous word or the ambiguous phrase or sequentially arranges and outputs only the single-meaning words or the single-meaning phrases on an additional window.

The word/phrase choosing unit 512 selectively receives from the user any one single-meaning word or single-meaning phrase among the single-meaning words or the single-meaning phrases. The word/phrase choosing unit 512 may output at least one button between a corresponding word selection button and a corresponding word non-selection button at one side of each single-meaning word or output at least one button between a corresponding phrase selection button and a corresponding phrase non-selection button at one side of each single-meaning phrase.

The translation result verification is performed before transferring the translation result to the counterpart. The translation result verification is a process in which when it is doubted that the error occurs in the translation result, the doubt is verified to the user.

\textcircled{3} Response Based Verification

The retranslation input unit 421 serves to transfer the translation text for the first input text to the user's counterpart and thereafter, receive whether the translation text is to be retranslated from the user according to a counterpart's reaction for the translation text.

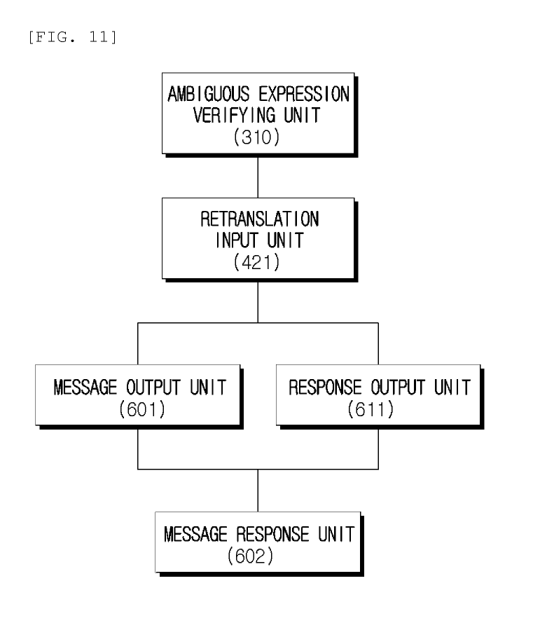

FIG. 11 is a block diagram illustrating an internal configuration of a retranslation input unit illustrated in FIG. 7. A mistranslation of the translation text may be determined after visually verifying the counterpart's reaction, but the mistranslation may be determined by the interactive interpretation and translation server 11 or the interactive interpretation and translation terminal 21.

In the case where the mistranslation is determined by the user, the retranslation input unit 421 may include a response output unit 611 and a message response unit 602. The response output unit 611 outputs a response of the counterpart that receives the translation text. The response output unit 611 outputs the response as a character input by the counterpart or an image acquired by photographing a counterpart's gesture. The message response unit 602 receives whether the translation text is to be retranslated from the user who verifies the response.

Meanwhile, when the interactive interpretation and translation server 11 or the interactive interpretation and translation terminal 21 is to determine the mistranslation, the retranslation input unit 421 may include a message output unit 601 and a message response unit 602. The message output unit 601 outputs a message to request retranslation of the translation text when the counterpart who receives the translation text has no response for a predetermined time or a word or a phrase that means that the translation text is unable to be understood is included in the counterpart's response. The message response unit 602 receives whether the translation text is to be retranslated from the user who verifies the message.

The second back translation text output unit 422 serves output the back translation text together with the first input text when the input is the retranslation request of the translation text.

The identity input unit 412, the other meaning phrase output unit 413, and the second selective input unit 414 have already been described in the case of the translation result verification, and as a result, herein, a detailed description thereof will be omitted.

The response based verification is the same as the case of the translation result verification in the process after the user's translation result is determined to be erroneous because the user's translation result is not understood to the counterpart. However, the response based verification determines whether the translation is erroneous through user's reaction unlike the translation result verification.

The response based verification is constituted by two types below.
Detecting occurrence of user's response based translation error
Repreparing error determination information providing based original text

In detecting the occurrence of the user's response based translation error, it is determined how the user responds to the translation result of the original text to determine whether the translation is erroneous. In the error determination, the user may detect various cases in which the user responds to the case where a translation text which is unable to be understood in the dialogue by the occurrence of the translation error.

When the translation error possibility is detected by the user's reaction as above, the original text repreparation result based on the back translation and the original text link information similarly as the case of the translation result verification to allow an original text preparer to determine the translation error, and as a result, the original text is induced to be reprepared to a text without the translation error.

As described above, in the present invention, whether the translation is erroneous by dividing the verification into the original text analysis verification, the translation result verification, and the response based verification in order to exclude texts having the error possibility from a context configuration and thus, the context may be accurately configured to achieve a more accurate translation and a correct dialogue within an earlier time.

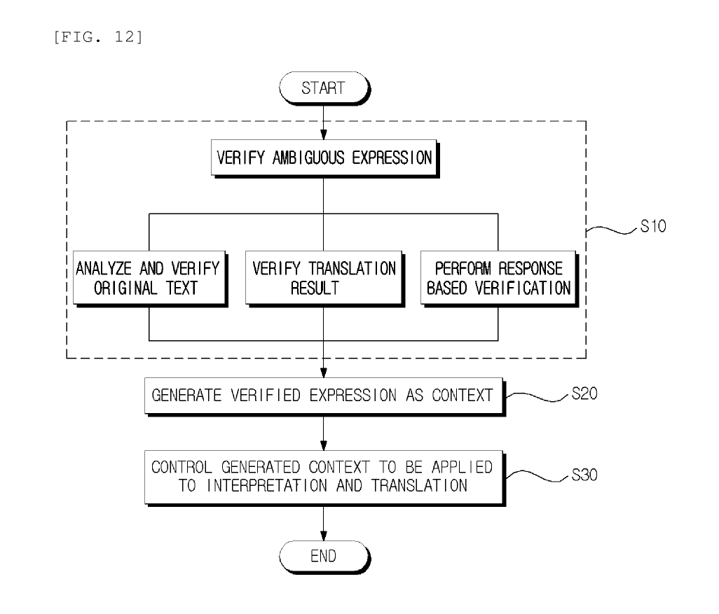

Next, a method for verifying a context of the apparatus for verifying a context will be described. FIG. 12 is a schematic flowchart of a method for verifying a context according to an exemplary embodiment of the present invention. The method for verifying a context according to the exemplary embodiment may be performed in a server that provides at least one function of a messenger function, an interactive translation function, and an interactive interpretation function between the first user terminal that outputs the input text through the first language and the second user terminal that outputs the input text through the second language. The method for verifying a context may be performed in a terminal with at least one program of an inactive translation program and an interactive interpretation program and an input device. The following description will refer to FIGS. 6 and 7 and FIGS. 10 to 12.

First, the ambiguous expression verifying unit 310 verifies an ambiguous expression in a first input text or a back translation text for the first input text according to user's input. The ambiguous expression verifying unit 310 verifies the ambiguous expression according to any one verification method of the original text analysis verification, the translation result verification, and the response based verification (S10). Hereinafter, each verification method will be described.

In the case of the original text analysis verification, when an ambiguous text is provided as the ambiguous expression, the meaning dividing output unit 401 divides the ambiguous text into single-meaning texts containing respective meanings and outputs the corresponding texts. In the case where an ambiguous word is provided as the ambiguous expression, the meaning dividing output unit 401 divides the ambiguous word into single-meaning words containing respective meanings and outputs the corresponding words.

The meaning dividing output unit 401 may divide and output the respective single-meaning texts according to paraphrasing or divides and outputs the respective single-meaning words into characters or images.

The meaning dividing output unit 401 may sequentially arrange single-meaning texts in any one part of an upper part and a lower part of the ambiguous text on one window in one direction and output the arranged single-meaning texts, sequentially arrange and output only single-meaning texts on an additional window in one direction, sequentially arrange and output single-meaning words in any one part of upper, lower, left, and right parts of the ambiguous word in one direction on one window, or sequentially arrange and output only the single-meaning words on an additional window in one direction.

Thereafter, the first selective input unit 402 selectively receives any one single-meaning text or single-meaning word among the single-meaning texts or the single-meaning words from the user.

The first selective input unit 402 may output at least one button between a corresponding text selection button and a corresponding text non-selection button at one side of each single-meaning text or output at least one button between a corresponding word selection button and a corresponding word non-selection button at one side of each single-meaning word.

In the case of the translation result verification, first, the first back translation text output unit 411 outputs the back translation text together with the first input text before delivering the translation text for the first input text to the user's counterpart.

Thereafter, the identity input unit 412 inputs whether the back translation text and the first input text have meaning identity.

Thereafter, in the case where the input indicates that the back translation text and the first input text do not have the meaning identity, the other meaning phrase output unit 413 outputs a single-meaning word or a single-meaning phrase containing a meaning other than an output meaning of an ambiguous word or an ambiguous phrase of the first input text which has a different meaning from the back translation text.

Thereafter, the second selective input unit 414 receives whether the output single-meaning word or single-meaning phrase is selected from the user in the case where the number of the output single-meaning words or single-meaning phrase is one and selectively receives from the user any one single-meaning word or single-meaning phrase among the output single-meaning words or single-meaning phrases in the case where the number of the output single-meaning words or single-meaning phrase is at least two.

When the number of the single-meaning words or the single-meaning phrases is one, first, the word/phrase output unit 501 outputs the single-meaning word or the single-meaning phrase and thereafter, the selection input unit 502 receives from the user whether to select the output single-meaning word or single-meaning phrase. The other phrase input unit 520 receives other single-meaning words or single-meaning phrases from the user when the user does not select the output single-meaning or single-meaning phrase.

When the number of the single-meaning words or the single-meaning phrases, is at least two, the word/phrase arranging unit 511 sequentially arranges and outputs the single-meaning words or the single-meaning phrases in one direction in any one part of upper, lower, left, and right parts of the ambiguous word or the ambiguous phrase or sequentially arranges and outputs only the single-meaning words or the single-meaning phrases on an additional window. Thereafter, the word/phrase choosing unit 512 selectively receives from the user any one single-meaning word or single-meaning phrase among the single-meaning words or the single-meaning phrases. The word/phrase choosing unit 512 outputs at least one button between a corresponding word selection button and a corresponding word non-selection button at one side of each single-meaning word or outputs at least one button between a corresponding phrase selection button and a corresponding phrase non-selection button at one side of each single-meaning phrase.

In the case of the response based verification, the retranslation input unit 421 transfers the translation text for the first input text to the user's counterpart and thereafter, receives whether the translation text is to be retranslated from the user according to a counterpart's reaction for the translation text.

In the case where the user determines the mistranslation of the translation text by visually verifying the counterpart's reaction, first, the response output unit 611 outputs the response of the counterpart who receives the translation text and thereafter, the message response unit 602 receives whether the translation text is to be retranslated from the user who verifies the response.

Meanwhile, in the case where the interactive interpretation and translation server 11 or the interactive interpretation and translation terminal 21 determines that the translation text is the mistranslated, first, the message output unit 611 outputs a message to request the retranslation of the translation text when the counterpart who receives the translation text has no response for a predetermined time or a word or a phrase that means that the translation text is unable to be understood is included in the counterpart's response and thereafter, the message response unit 602 receives whether the translation text is to be retranslated from the user who verifies the message.

Thereafter, the second back translation text output unit 422 outputs the back translation text together with the first input text when the input is the retranslation request of the translation text.

Thereafter, the identity input unit 412 inputs whether the back translation text and the first input text have meaning identity.

In the case where the input indicates that the back translation text and the first input text do not have the meaning identity, the other meaning phrase output unit 413 outputs a single-meaning word or a single-meaning phrase containing a meaning other than an output meaning of an ambiguous word or an ambiguous phrase of the first input text which has a different meaning from the back translation text.

Thereafter, the second selective input unit 414 receives whether the output single-meaning word or single-meaning phrase is selected from the user in the case where the number of the output single-meaning words or single-meaning phrase is one and selectively receives from the user any one single-meaning word or single-meaning phrase among the output single-meaning words or single-meaning phrases in the case where the number of the output single-meaning words or single-meaning phrase is at least two.

After step S10, the context generating unit 320 generates the verified ambiguous expression as the context (S20).

After step S20, the context controlling unit 330 controls the generated context to be applied to translate or interpret the first input text or second input texts input after the first input text (S30).

Meanwhile, the embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An apparatus for verifying a context, comprising:
an ambiguous expression verifying unit verifying an ambiguous expression in a first input text or a back translation text for the first input text in accordance with user's input;
a context generating unit generating the verified ambiguous expression as a context; and
a context controlling unit controlling the generated context to be applied to translate or interpret the first input text or second input texts input after the first input text.

2. The apparatus of claim 1, wherein:
the ambiguous expression verifying unit includes
a meaning dividing output unit dividing the ambiguous text into single-meaning texts containing respective meanings and outputting the corresponding texts in the case where an ambiguous text is provided as the ambiguous expression; and
a first selective input unit selectively receiving any one single-meaning text or single-meaning word among the single-meaning texts or the single-meaning words from the user.

3. The apparatus of claim 2, wherein the meaning dividing output unit divides and outputs the respective single-meaning texts or divides and outputs the respective single-meaning words into characters or images.

4. The apparatus of claim 2, wherein the meaning dividing output unit sequentially arranges single-meaning texts in any one part of an upper part and a lower part of the ambiguous text on one window in one direction and outputs the arranged single-meaning texts, sequentially arranges and outputs only single-meaning texts on an additional window in one direction, sequentially arranges and outputs single-meaning words in any one part of upper, lower, left, and right parts of the ambiguous word in one direction on one window, or sequentially arranges and outputs only the single-meaning words on an additional window in one direction.

5. The apparatus of claim 2, wherein the first selective input unit outputs at least one button between a corresponding text selection button and a corresponding text non-selection button at one side of each single-meaning text or outputs at least one button between a corresponding word selection button and a corresponding word non-selection button at one side of each single-meaning word.

6. The apparatus of claim 1, wherein:
the ambiguous expression verifying unit includes
a first back translation text output unit outputting a back translation text together with the first input text before delivering the translation text for the first input text to a user's counterpart;
an identity input unit inputting whether the back translation text and the first input text have a meaning identity;
an other meaning phrase output unit outputting a single-meaning word or a single-meaning phrase containing a meaning other than an output meaning of an ambiguous word or an ambiguous phrase of the first input text which has a different meaning from the back translation text in the case where the input indicates that the back translation text and the first input text do not have the meaning identity; and
a second selective input unit receiving whether the output single-meaning word or single-meaning phrase is selected from the user in the case where the number of the output single-meaning words or single-meaning phrase is one and selectively receiving from the user any one single-meaning word or single-meaning phrase among the output single-meaning words or single-meaning phrases in the case where the number of the output single-meaning words or single-meaning phrase is at least two.

7. The apparatus of claim 6, wherein:
the second selective input unit includes
a word/phrase output unit outputting the single-meaning word or the single-meaning phrase when the number of the single-meaning words or the single-meaning phrases is one; and
a selection input unit receiving from the user whether the output single-meaning word or single-meaning phrase is to be selected, and
the ambiguous expression verifying unit further includes
an other phrase input unit receiving other single-meaning words or single-meaning phrases from the user when the user does not select the output single-meaning or single-meaning phrase.

8. The apparatus of claim 6, wherein:
the second selective input unit includes
a word/phrase arranging unit sequentially arranging and outputting the single-meaning words or the single-meaning phrases in one direction in any one part of upper, lower, left, and right parts of the ambiguous word or the ambiguous phrase or sequentially arranging and outputting only the single-meaning words or the single-meaning phrases on an additional window when the number of the single-meaning words or the single-meaning phrases is at least two; and
a word/phrase choosing unit selectively receiving from the user any one single-meaning word or single-meaning phrase among the single-meaning words or the single-meaning phrases.

9. The apparatus of claim 8, wherein the word/phrase choosing unit outputs at least one button between a corresponding word selection button and a corresponding word non-selection button at one side of each single-meaning word or output at least one button between a corresponding phrase selection button and a corresponding phrase non-selection button at one side of each single-meaning phrase.

10. The apparatus of claim 1, wherein:
the ambiguous expression verifying unit includes
a retranslation input unit transferring the translation text for the first input text to the user's counterpart and thereafter, receiving whether the translation text is to be retranslated from the user according to a counterpart's reaction for the translation text;
a second back translation text output unit outputting the back translation text together with the first input text when the input is the retranslation request of the translation text;
an identity input unit inputting whether the back translation text and the first input text have a meaning identity;
an other meaning phrase output unit outputting a single-meaning word or a single-meaning phrase containing a meaning other than an output meaning of an ambiguous word or an ambiguous phrase of the first input text which has a different meaning from the back translation text in the case where the input indicates that the back translation text and the first input text do not have the meaning identity; and
a second selective input unit receiving whether the output single-meaning word or single-meaning phrase is selected from the user in the case where the number of the output single-meaning words or single-meaning phrase is one and selectively receiving from the user any one single-meaning word or single-meaning phrase among the output single-meaning words or single-meaning phrases in the case where the number of the output single-meaning words or single-meaning phrase is at least two.

11. The apparatus of claim 10, wherein:
the retranslation input unit includes
a message output unit outputting a message to request retranslation of the translation text when the counterpart who receives the translation text has no response for a predetermined time or a word or a phrase that means that the translation text is unable to be understood is included in the counterpart's response; and
a message response unit receiving whether the translation text is to be retranslated from the user who verifies the message.

12. The apparatus of claim 10, wherein:
the retranslation input unit includes
a response output unit outputting a response of the counterpart who receives the translation text; and
a message response unit receiving whether the translation text is to be retranslated from the user who verifies the response.

13. The apparatus of claim 12, wherein the response output unit outputs the response as a character input by the counterpart or an image acquired by photographing a counterpart's gesture.

14. The apparatus of claim 1, wherein the ambiguous expression verifying unit uses use a text input through the voice or a text input through an input device such as a key pad or a touch pad as the first input text.

15. The apparatus of claim 1, wherein the apparatus for verifying a context is mounted on a server that provides at least one function of a messenger function, an interactive translation function, and an interactive interpretation function between the first user terminal that outputs the input text through the first language and the second user terminal that outputs the input text through the second language or mounted on a terminal with at least one program of an interactive translation program and an interactive interpretation program and an input device.

16. A method for verifying a context, comprising:
verifying an ambiguous expression in a first input text or a back translation text for the first input text in accordance with user's input;
generating the verified ambiguous expression as a context; and
controlling the generated context to be applied to translate or interpret the first input text or second input texts input after the first input text.

17. The method of claim 16, wherein:
the verifying of the ambiguous expression includes
dividing the ambiguous text into single-meaning texts containing respective meanings and outputting the corresponding texts in the case where an ambiguous text is provided as the ambiguous expression and dividing the ambiguous word into single-meaning words containing respective meanings and outputting the corresponding words in the case where an ambiguous word is provided as the ambiguous expression; and
selectively receiving any one single-meaning text or single-meaning word among the single-meaning texts or the single-meaning words from the user.

18. The method of claim 16, wherein:
the verifying of the ambiguous expression includes
outputting a back translation text together with the first input text before delivering the translation text for the first input text to a user's counterpart;
inputting whether the back translation text and the first input text have a meaning identity;
outputting a single-meaning word or a single-meaning phrase containing a meaning other than an output meaning of an ambiguous word or an ambiguous phrase of the first input text which has a different meaning from the back translation text in the case where the input indicates that the back translation text and the first input text do not have the meaning identity; and
receiving whether the output single-meaning word or single-meaning phrase is selected from the user in the case where the number of the output single-meaning words or single-meaning phrase is one and selectively receiving from the user any one single-meaning word or single-meaning phrase among the output single-meaning words or single-meaning phrases in the case where the number of the output single-meaning words or single-meaning phrase is at least two.

19. The method of claim 16, wherein:
the verifying of the ambiguous expression includes
transferring the translation text for the first input text to the user's counterpart and thereafter, receiving whether the translation text is to be retranslated from the user according to a counterpart's reaction for the translation text;
outputting the back translation text together with the first input text when the input is the retranslation request of the translation text;
inputting whether the back translation text and the first input text have a meaning identity;
outputting a single-meaning word or a single-meaning phrase containing a meaning other than an output meaning of an ambiguous word or an ambiguous phrase of the first input text which has a different meaning from the back translation text in the case where the input indicates that the back translation text and the first input text do not have the meaning identity; and
receiving whether the output single-meaning word or single-meaning phrase is selected from the user in the case where the number of the output single-meaning words or single-meaning phrase is one and selectively receiving from the user any one single-meaning word or single-meaning phrase among the output single-meaning words or single-meaning phrases in the case where the number of the output single-meaning words or single-meaning phrase is at least two.

20. The method of claim 16, wherein the method for verifying a context is performed on a server that provides at least one function of a messenger function, an interactive translation function, and an interactive interpretation function between the first user terminal that outputs the input text through the first language and the second user terminal that outputs the input text through the second language or performed on a terminal with at least one program of an interactive translation program and an interactive interpretation program and an input device.
